(19) United States
(12) Patent Application Publication
(10) Pub. No.: US 2025/0114181 A1
(43) Pub. Date: Apr. 10, 2025

(54) 3D-PRINTED INSTRUMENT FOR EQUINE CHONDROID REMOVAL

(71) Applicant: VIRGINIA TECH INTELLECTUAL PROPERTIES, INC., Blacksburg, VA (US)

(72) Inventors: Sophie H. Bogers, Blacksburg, VA (US); Guillermo C. Cardona, Wrentham, MA (US)

(21) Appl. No.: 18/909,045

(22) Filed: Oct. 8, 2024

Related U.S. Application Data
(60) Provisional application No. 63/588,768, filed on Oct. 9, 2023.

(51) Int. Cl. A61D 1/00

(52) U.S. Cl. CPC A61D 1/00

(57) ABSTRACT

Disclosed are various embodiments providing devices for lavage of a deeply recessed area and methods for using the same, such as in equine chondroid removal. The device can include a hollow insertion portion having a straight portion and a flexible curved distal end with a fluid egress aperture on a convex side of the curve and a rigid tubular handle connected to the straight portion of the hollow insertion portion.

### CROSS-REFERENCE TO RELATED APPLICATIONS

This application claims the benefit of U.S. Provisional Application No. 63/588,768, filed Oct. 9, 2023, the entire contents of which is hereby incorporated herein by reference.

### BACKGROUND

Strangles is a highly contagious equine infection caused by Streptococcus equi subspecies equi (S. equi) that causes fever, nasal discharge and abscesses near swollen lymph nodes. Strangles and other infections can cause chondroids. Strangles causes serious complications in 20% of infected horses, including chondroid formation in the guttural pouches (GP). Chondroids are smooth concretions of inspissated pus that can result following chronic bacterial infection of the GP in horses due to impaired mucociliary mechanisms and narrowing or closure of the salpingopharyngeal ostium (SPO) from inflammation. The result is failure of GP drainage. Chondroids can be caused by a variety of bacteria, including Streptococcus equi subsp zooepidemicus and Corynebacterium pseudotuberculosis, but are commonly a result of Strangles (Streptococcus equi subsp equi) infection.

Chondroid removal is used as a means to prevent asymptomatic transmission of Strangles; however available chondroid removal techniques have significant limitations. These limitations include prolonged procedural time, high cost and unwanted post-operative complications. One standard method for chondroid removal includes using an endoscopic basket, which is essentially a wire loop or basket on the end of a handle, but this method is not effective and can cause injury. Endoscopic basket removal of individual chondroids can take hours spread over multiple days and success depends on the degree of pathology and the number of chondroids present. Some horses do not tolerate endoscopic removal despite heavy sedation. For these reasons, endoscopic removal frustrates clinicians, often requiring lavage with tubes via the salpingopharyngeal ostium. Lavage without patent egress can cause iatrogenic rupture of the guttural pouches with subsequent drainage of the purulent material into surrounding tissues.

Surgical removal is more efficient for removal of multiple guttural pouch chondroids; however, open surgical approaches, such as hyovertebrotomy and the modified Whitehouse, are costly and expose surgical rooms to Streptococcal contamination because they require general anesthesia. The Garm, Viborg's triangle and modified Whitehouse techniques can be performed standing but surgeon position and visualization are difficult. Open surgical approaches are also complicated by proximity to critical neurovascular structures, including the jugular vein, carotid artery and parotid duct, as well as the glossopharyngeal nerve, pharyngeal branch of the vagal nerve and cranial laryngeal nerve. Therefore, these surgical approaches carry a risk of nerve damage that could result in dysfunction of the tongue, pharynx or larynx. Post-operative leakage of infected material into interstitial tissues can also occur. For these reasons, improved means of removing GP chondroids without the need for open surgery is warranted. These and other needs are addressed by the present disclosure.

### SUMMARY

Embodiments of the present disclosure provide for devices and methods for lavage of body cavities.

An embodiment of the present disclosure includes a device for lavage of a deeply recessed area. The device can include a hollow insertion portion having a straight portion and a flexible curved distal end, the curved distal end having a fluid egress aperture on a convex side of the curve. The device can also include a rigid tubular handle connected to or integral with the straight portion of the hollow insertion portion.

An embodiment of the present disclosure also includes a tool for equine chondroid removal having a hollow insertion portion. The insertion portion can include a straight portion and a curved distal end having a fluid egress aperture on a convex side of the curve. The curved distal end is flexible and terminates in a bulbous nub. The tool also includes a rigid tubular handle connected to the straight portion of the hollow insertion portion.

An embodiment of the present disclosure also includes a method for fluid lavage of a deeply recessed area. The proximal end of a device for lavage egress receives a lavage tube that is connected to a fluid source. A distal end of the device is inserted into the deeply recessed area such that a flexible curved distal end of the device enters the deeply recessed area, and the deeply recessed area is lavaged by fluid passing through a fluid egress aperture on a convex side of the curved distal end.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1A is a perspective view diagram of a tool according to various example embodiments; FIG. 1B is a front view diagram of a tool according to various example embodiments; FIG. 1C is a side view diagram of a tool according to various example embodiments; FIG. 1D is a diagram illustrating the hollow handle of the tool according to various example embodiments; FIG. 1E is a cross-section side view diagram of a tool according to various example embodiments; FIG. 1F is a photograph of a 3D-printed tool according to various example embodiments; FIG. 1G is a close-up photograph of the hollow insertion portion of a 3D-printed tool, including the straight portion and the curved distal end, according to various example embodiments; FIG. 1H is a close-up photograph of the curved distal end and the fluid egress aperture, according to various example embodiments; FIG. 1I is a schematic drawing of a 3D-printed instrument for removal of guttural pouch chondroids.

FIG. 2 is a schematic diagram of showing an experimental flow for testing the tool in accordance with various example embodiments and described in the Example. Dorsal pharyngeal recess (DPR) fenestration was created into one guttural pouch of an equine cadaveric head and plastic beads were inserted to create a model of guttural pouch chondroids. The first group of heads were randomly assigned to procedures that had 3D-printed instrument (DPR+3D) or lavage tube control (DPR−3D) placed directly through the DPR fenestration. Then, the second group of heads were randomly assigned to procedures that had 3D-printed instrument (SPO+3D) or lavage tube control (SPO−3D) placed through the salpingopharyngeal ostium. All procedures used pulsed lavage cycles followed by bead counts that were repeated until endpoints were reached. Soft-tissue damage was assessed using endoscopic examination before, during and after laser fenestration and bead removal procedures (red checkmark). Undamaged heads were re-used for the alternate procedure after replacement of plastic beads so that each head was used for 2 procedures. This flow was repeated until there were at least 10 repeats of each procedure.

FIG. 3 provides an example endoscopic image of the transpharyngeal fenestration of the left guttural pouch in the dorsal pharyngeal recess taken from the right nasal passage of a horse.

FIGS. 4A-4D are photographic images of an example set up for the cadaveric model of equine guttural pouch chondroids experiments as described in the Example. Cadaveric equine head (FIG. 4A) set at an angle of 78±5° to mimic live horse with head relaxation during standing sedation (FIG. 4B). Plastic beads inserted into the guttural pouch seen from outside (FIG. 4C) and inside (FIG. 4D) the DPR fenestration filled the ventral portion of the medial and lateral compartments.

FIGS. 5A-5D are diagrammatic representations of four procedures to remove plastic beads via a dorsal pharyngeal recess fenestration of the guttural pouch. Endoscopic images are of the equine pharynx showing procedures performed on the right side. A square fenestration made with transendoscopic laser in the dorsal pharyngeal recess (dashed line) communicates with the right guttural pouch in which beads are placed (white circles). Bead removal procedures using a 3D-printed instrument (FIGS. 4A, 4C) or lavage tube control (FIGS. 4B, 4D) placed directly through the fenestration (top row: 4A, 4B) or through the salpingopharyngeal ostium (bottom row: 4C, 4D). Beads egress through the dorsal pharyngeal fenestration.

FIG. 6 is a graph plotting the total number plastic beads removed for each procedure group. DPR+3D, 3D-printed instrument via fenestration; SPO+3D, 3D-printed instrument via salpingopharyngeal ostium; DPR−3D, lavage tube control via fenestration; SPO−3D, lavage tube control via salpingopharyngeal ostium. Dots represent each procedure, lines represent median beads removed. Superscript letters indicate groups significantly different from one another.

FIG. 7 is a graph showing the number of plastic beads removed after each 2-minute lavage cycle. DPR+3D (red) 3D-printed instrument via fenestration; SPO+3D (blue) 3D-printed instrument via salpingopharyngeal ostium; DPR−3D (yellow) lavage tube control via fenestration; SPO−3D (green) lavage control via salpingopharyngeal ostium. Each dot represents an individual procedure with lines following the median rate of bead removal for each group at each time point.

FIG. 8 is a photograph showing an example of mucosal damage after laser fenestration procedure. The red dashed circle shows superficial laser damage on the right wall of the pharynx after surgical laser fenestration.

FIGS. 9A and 9B are photographs showing examples of sub-mucosal edema after lavage procedure. FIG. 9A: mucosal edema that impinged on pharynx; FIG. 9B: mucosal undermining with flap formation (black arrow) occluding the fenestration site.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Provided herein is a hollow instrument with a flexible, atraumatic tip that can be attached to a fluid lavage system to aid in guided lavage. The instrument can be used, among other applications, to help horses who have formed balls of concreted pus called chondroids in a structure of the airway called the guttural pouch. Access to this structure is extremely difficult due to its depth. The instrument described herein allows safe, guided lavage with efficient removal of chondroids or other ovoid structures by facilitating grouping of the objects and mechanical removal. The instrument is amenable to single use and could assist any medical procedure that requires lavage of structures located with a deep, narrow access. Advantageously, the instrument can be 3D-printed to allow for cost-effective and widespread availability.

Also provided herein are methods of chondroid removal which include use of the tool as described above.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of equine anatomy, veterinary sciences, biomedical sciences, and the like, which are within the skill of the art.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### Abbreviations

Dorsal pharyngeal recess (DPR); guttural pouch (GP); salpingopharyngeal ostium (SPO)

### General Discussion

In accordance with the purpose(s) of the present disclosure, as embodied and broadly described herein, embodiments of the present disclosure, in some aspects, relate to

In general, embodiments of the present disclosure provide for tools and methods for lavage of deeply recessed areas, including but not limited to equine guttural pouches.

An embodiment of the present disclosure includes a device for lavage of a deeply recessed area. The device can include a hollow insertion portion connected to a rigid tubular handle. The insertion portion, which inserts into the deeply recessed area, can be formed from a straight portion and a curved distal end having a fluid egress aperture on a convex side of the curve. Advantageously, the distal end is flexible to prevent damage to the soft tissues.

In various embodiments, the device is a long and slender device for fluid egress into difficult to reach anatomical areas. The hollow device delivers fluid from a lavage through the rigid handle such that the fluid exits from an aperture located in the convex curve of the distal end. Advantageously, the distal end—or the end inserted into a human or animal patient, opposite the fluid receiving end—is curved. This curved end is made from a flexible material and can be used to gently agitate and dislodge matter such as chondroids while preventing soft tissue damage. The flexible, curved end can also have a spade-like or scooped shape to assist in matter removal. In some embodiments, the curved distal end terminates in a bulbous nub. Such a nub provides a rounded, atraumatic contact point with the soft tissues to further prevent damage. The fluid egress aperture is positioned near the distal end and in the convex surface of the curve to cause the fluid to flush the target site and aid in removal of chondroids or other matter to be removed from the target site. The device is structured to provide fluid egress for flushing, rather than suction.

While the examples and discussion provided herein are primarily drawn to instruments and methods for removing chondroids from the guttural pouch of horses or other equids, the device can easily be scaled for use in other applications in which deep recesses may require lavage. Such other applications can include areas such as a bladders, a cervix, a uterus, or an ear canal. The patient can be a human or non-human animal.

In some embodiments, the device can be inexpensively made using 3D printing. The device can be fully or partially disposable. In a particular embodiment, the handle can be a rigid material such as polylactic acid (PLA) and the insertion portion can be a flexible material. The flexible material can be silicone, flexible thermoplastic polyurethane, or other similar material. In some embodiments, the insertion end and the handle can be formed as a single, integral piece formed using multi-material additive manufacturing techniques. In other embodiments, the insertion end and the handle can be formed as separate elements. Each element can be formed from one or more segments to accommodate various printer sizes.

Other materials and manufacturing processes can be used, as can be appreciated by a person having ordinary skill in the art. The handle can be formed from any rigid materials suitable for forming a hollow tube and appropriate for surgical use. The distal end of the insertion portion should be a flexible material appropriate for surgical use. The curved end should be flexible enough to allow for gentle manipulation of structures within the body cavity without causing soft tissue damage but should be rigid enough so that the insertion portion maintains its shape and structure during use. For non-disposable embodiments, the material should be capable of sterilization. Some or all of the materials can be provided with an antifouling coating.

In embodiments in which the insertion portion is entirely made from a flexible material, the straight portion can be internally reinforced with tubing or a sheath to lend rigidity. In other embodiments, the material of the straight portion can be thickened to lend rigidity.

In various embodiments the handle can provide additional rigidity to the flexible insertion portion, where the handle is lengthened such that the straight portion forms a sleeve over the handle.

As can be envisioned by a person having ordinary skill in the art, in embodiments in which the handle and the insertion portion are non-integral, the two parts can be connected to one another in a variety of ways. For example, the distal end of the handle and the proximal end of the insertion portion could be threaded together or attached by a threaded connector. In other embodiments, the two ends could be jointed together or friction fitted.

In some embodiments, the proximal end of the handle can include a coupling or connector to clamp or connect the handle to the fluid source. The fluid source can be such as lavage tubing or a dosing syringe.

Turning now to the drawings, exemplary embodiments are described in detail.

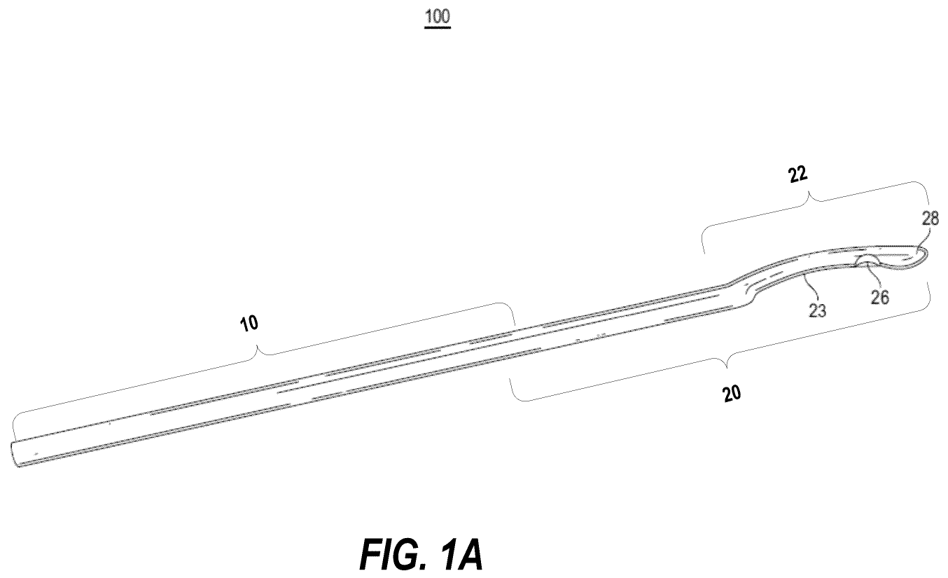

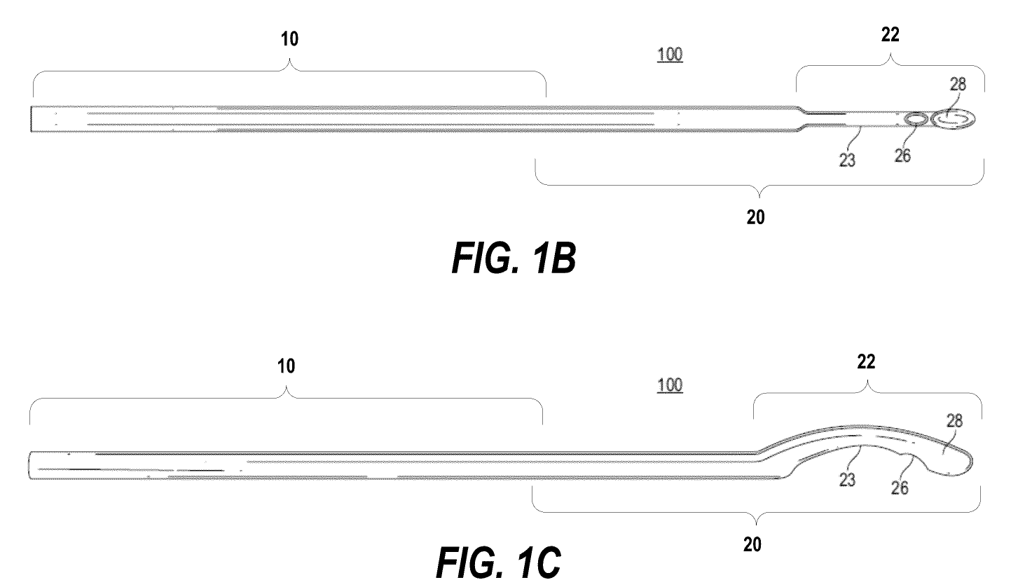

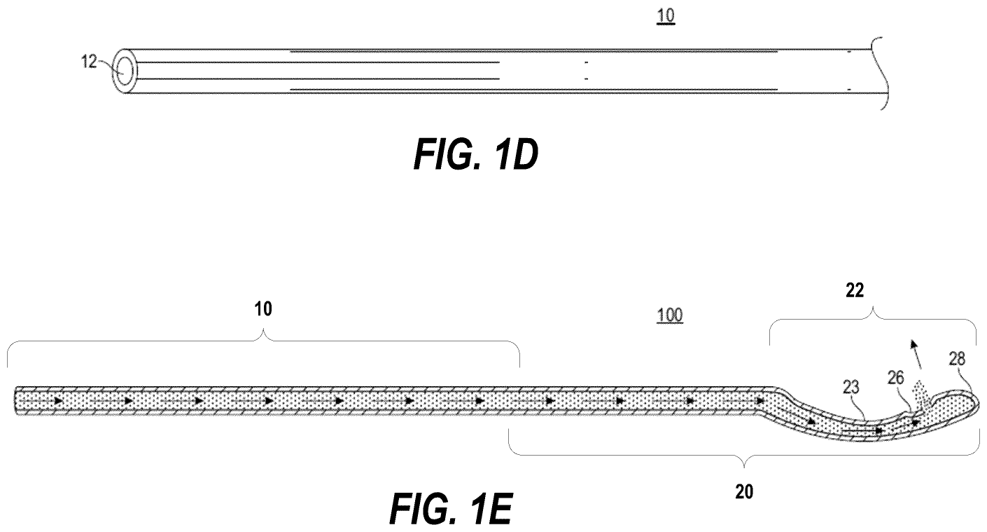

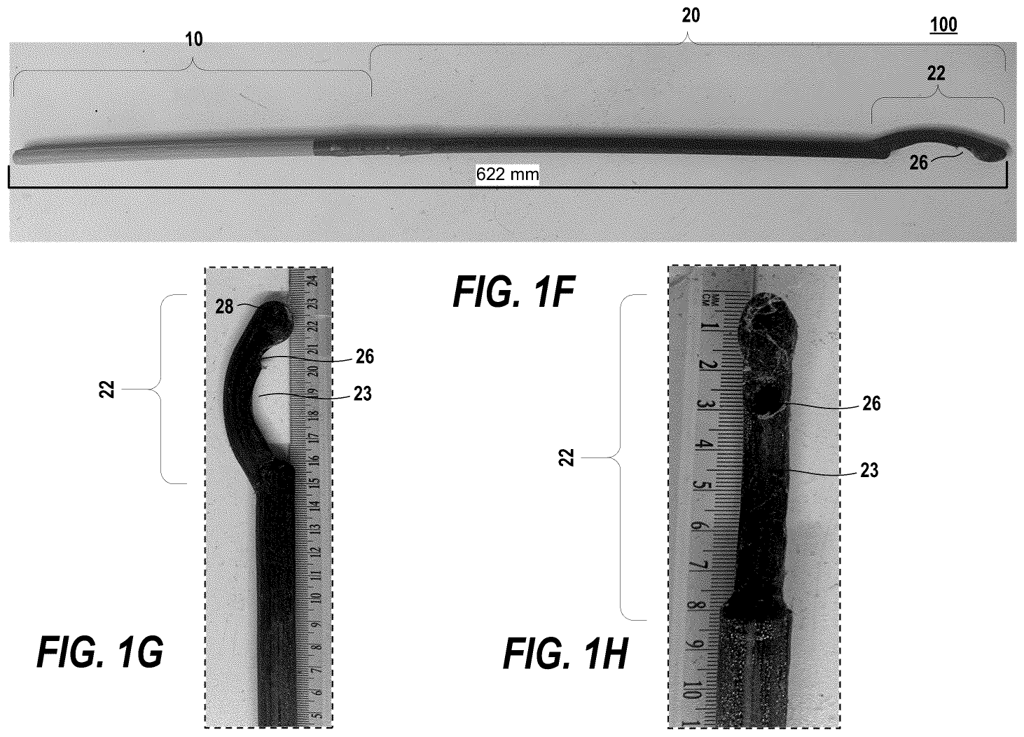

FIGS. 1A-1E show an exemplary embodiment of the device described herein. FIG. 1A is a perspective view of the device 100. The device 100 is hollow, allowing fluid to pass from a fluid delivery device (not shown) through the internal channel of handle 10 into the insertion portion 20, exiting from the fluid egress aperture 26. Handle 10 is connected to insertion portion 20. Insertion portion 20 includes flexible curved portion 22. The concave side 23 of curved portion 22 includes fluid egress aperture 26. The atraumatic tip or nub 28 is not hollow. The device depicted herein is shown as having an integral handle 10 and insertion portion 20, but could be separate pieces as described above. The handle 10 and insertion portion 20 can have varying lengths relative to one another. FIG. 1B shows the device 10 from the front view, or concave side 23. FIG. 1C shows a side view. FIG. 1D shows an embodiment of the handle 10, where the internal channel 12 is visible on the proximal end where fluid enters from the lavage. FIG. 1E is a cross section through the side view of device 100. Arrows indicate the path of fluid entering the internal channel 12 from the lavage, flowing through the handle 10 through the insertion portion 22 and exiting from the fluid egress aperture 26. In some embodiments, the diameter of the fluid egress aperture 26 is approximately the same diameter as the internal channel 12.

FIGS. 1F-1H are photographs of a 3D printed device 100 that is dimensioned for use in equine guttural pouch chondroid removal. The overall length of the device is about 622 mm. In this embodiment, the handle 10 and the insertion portion 20 are connected using an adhesive wrap. As can be seen from the closeups of the flexible curved portion 22 in FIGS. 1G and 1H, the flexible curved portion 22 is approximately 80 mm long the fluid egress aperture 26 is approximately 10 mm in diameter and the outer diameter of the handle and straight portions are approximately 11 mm. The curved portion 22 has a curvature of about 20 degrees in this example. Although the equine version is depicted, the overall dimensions of the device can be scaled for use in other applications, such as for use in miniature horses. The device can also be scaled for other body cavities or animals.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

As discussed above, existing surgical techniques for chondroid removal have limitations. Access to the guttural pouches using transendoscopic laser surgery is performed in the standing horse and has a lower risk of neural or vascular damage versus open surgical techniques. Transendoscopic surgery has been described for chondroid removal out of necessity due to fibrosis of the SPO via fenestration of the mesial septum, or by fenestration of the dorsal pharyngeal recess (DPR) coupled with lavage. Transpharyngeal GP fenestration has been used successfully for GP mycosisand tympany with no reported long term detriment. The relatively thinner tissue in the DPR requires less laser energy and time to create a fenestration to and gain access to the GP than fenestration caudal to the SPO. Koch, et al. recently demonstrated that fenestration of the DPR facilitated removal of empyema and chondroids with lavage and allowed continuous egress of mucopurulent material. However, success of lavage with DPR fenestration may vary between cases. One reported case required enlargement of the fenestration for successful chondroid removal. DPR fenestrations in most cases close spontaneously in the weeks to months following surgery. In rare cases a patent fistula may persist; however, this does not appear to pose a clinical problem.

The objectives of the study provided in this example were to determine if a technique using a 3D-printed instrument to provide mechanical agitation and lavage would improve efficacy for removal of plastic beads (mimicking GP chondroids) through a DPR fenestration, and to compare instrument placement directly through the DPR fenestration vs. through the SPO. We hypothesized that: 1) the 3D-printed instrument technique would recover more beads, reduce lavage time and incur less soft tissue damage than a technique with a lavage tube control; and 2) the 3D-printed instrument placement through the DPR would recover more plastic beads, reduce lavage time and incur in less soft tissue damage than placement through the SPO.

A hollow 3D-printed instrument that could be attached to a pressure-limiting pump was developed (FIGS. 1F-1I). To optimize the position of fluid egress, 12 mm solid plastic beads (Inspirelle, Yiwu, China) were placed into a resealable plastic bag in water and large bore insemination pipette protectors with an inner diameter of 0.610 cm (Continental Plastics, Delavan, WI) were manually bent 8 cm from the distal end and a 2 cm hole was created 2 cm from the distal end on the convex side or concave side using a number 10 scalpel blade. The tube was connected to an arthroscopic fluid pump (Endomat Select ART-LA, Karl Storz, Munich, Germany), and bead movement was observed for three repeats. Hole placement 2 cm from the distal end on the concave side grouped beads centrally in relation to the curvature of the instrument, positioning beads to be pulled by the distal tip of the instrument. In contrast, hole placement 2 cm from the distal end on the convex side dispersed beads, which was undesirable. Based on this pilot experiment, a 3D-printed tubular instrument was designed using Tinkercad software (Autodesk Inc.) and formatted for printing with CURA (CREATE Education). The instrument was printed diagonally across the bed of a 3D printer (Lulzbot Taz6, LulzBot®). Due to size limitations of the printer base, the instrument consisted of two portions: the first portion was printed using 2.85 mm flexible thermoplastic polyurethane (Ninjaflex, Ninjatek Fenner Precision Polymers, PA) with a total length of 410 mm. The distal 80 mm of the instrument was curved at 20° with a 10 mm long hole placed 20 mm from the distal end on the concave surface. The second portion consisted of a 212 mm stiff handle made of polylactic acid (PLA). The instrument had a total length of 622 mm, an outer diameter of 11 mm and inner diameter of 10 mm. FIG. 1I shows a schematic of a 3D printed version of the tool printed on a small bed printer. Due to the printer bed size, the thermoplastic polyurethane (TPU) portion (dark gray) was printed in 2 separate portions. A large bore insemination pipette ((Continental plastics, WI, not pictured) was inserted into the linear portion to provide rigidity while the curved portion remained flexible. A rigid polylactic acid handle (light gray) attached to the end of the instrument was used for attachment to tubing from the arthroscopic pump. Depending on the type of material used and the printer bed size, the TPU portion could be printed in a single piece and could be rigid enough such that additional reinforcement of the linear portion is not needed.

### Cadaveric Evaluation of 3D-Printed Instrument

### Cadaveric Specimens:

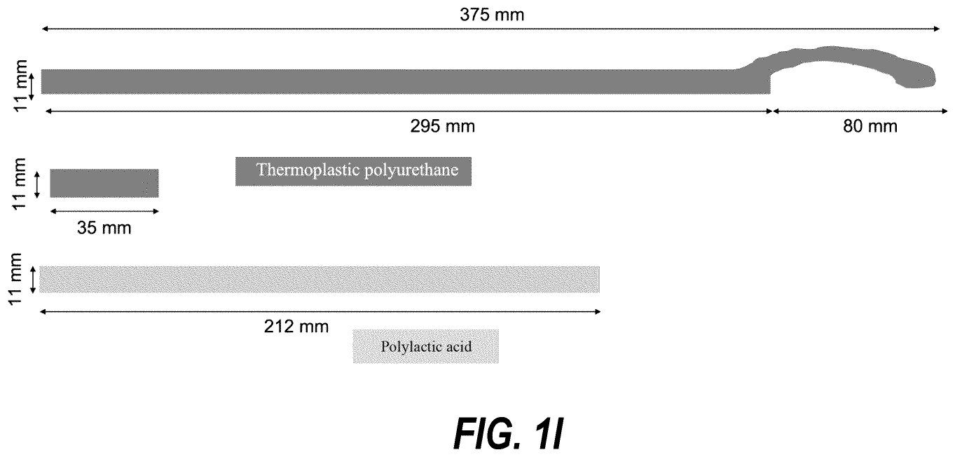

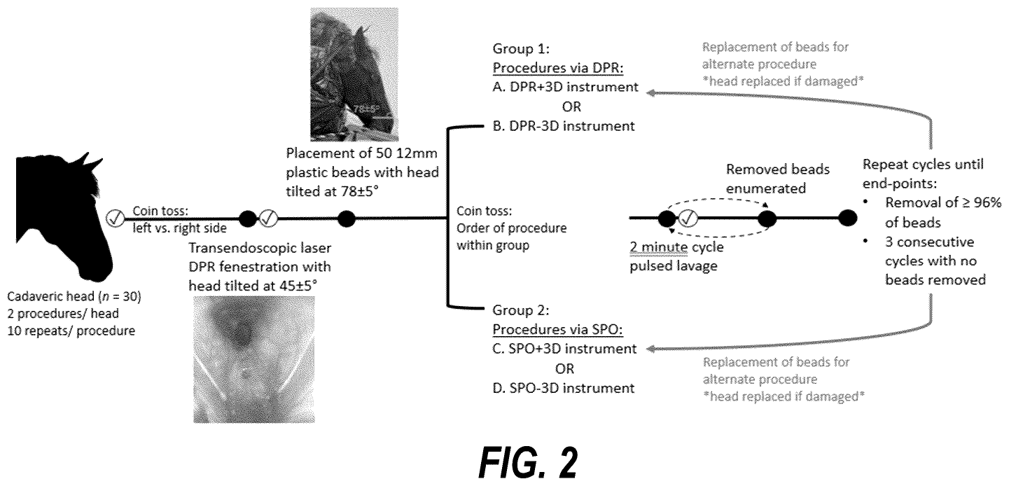

FIG. 2 shows the experimental flow for each cadaveric equine head for removal of plastic beads. Dorsal pharyngeal recess (DPR) fenestration was created into one guttural pouch of an equine cadaveric head and plastic beads were inserted to create a model of guttural pouch chondroids. The first group of heads were randomly assigned to procedures that had 3D-printed instrument (DPR+3D) or lavage tube control (DPR−3D) placed directly through the DPR fenestration. Then, the second group of heads were randomly assigned to procedures that had 3D-printed instrument (SPO+3D) or lavage tube control (SPO−3D) placed through the salpingopharyngeal ostium. All procedures used pulsed lavage cycles followed by bead counts that were repeated until endpoints were reached. Soft-tissue damage was assessed using endoscopic examination before, during and after laser fenestration and bead removal procedures (red checkmark). Undamaged heads were re-used for the alternate procedure after replacement of plastic beads so that each head was used for 2 procedures. This flow was repeated until there were at least 10 repeats of each procedure.

Thirty cadaveric heads transected at cervical vertebrae 3 and 4 were collected and stored at −20° C. within 24 hours of death from horses who died or were euthanized for reasons unrelated to the study and had no clinical history of guttural pouch disease. Specimens were sourced through the VMCVM Veterinary Teaching Hospital and Conboy Enterprises (Lexington, KY). Specimens derived from client-owned animals were used with written consent for use for research purposes. Heads from draft horses and ponies were excluded. Survey endoscopy was performed to confirm normal nasal passages and GP, as described below, prior to starting procedures to confirm inclusion. Each cadaveric head had one transendoscopic laser fenestration created in the DPR and 2 bead removal procedures. If damage occurred, a new head was obtained. Minor mucosal laceration or burn with the laser (<0.5 cm, partial thickness) were not considered damage that required a new head. Heads were thawed at 18° C. for 48 hours prior to use and secured on a metal frame using ropes and positioning wedges. The ventral aspect of the neck was protected against compression using a U-shaped cushion.

### GP Chondroid Model:

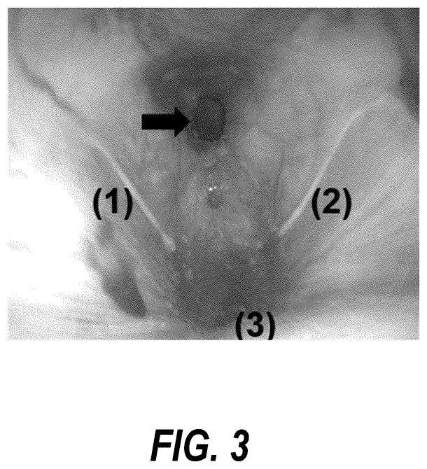

For transendoscopic fenestration of the DPR, heads were positioned so that the angle formed by the dorsal aspect of the nasal bone and the horizontal was 45±5° at the level of the nasoincisive notch. Head angle was confirmed with a digital miter angle finder and image analysis using Photo Protractor 2.6 (Goemon-soft 2015, Japan). A coin-toss was used to determine the side for unilateral laser fenestration of the DPR. A transendoscopic neodymium: yttrium-aluminum-garnet (Nd:YAG) laser (CL MD/220 100W, Surgical Laser Technologies Inc.) with 1.05 mm quartz fiber was used in contact fashion at 30W to create a 20 mm diameter fistula through the DPR into the assigned GP16 (FIG. 3). FIG. 3 provides an endoscopic image of the transpharyngeal fenestration of the left guttural pouch in the dorsal pharyngeal recess taken from the right nasal passage, where (1) indicates the right salpingopharyngeal ostium, (2) indicates the left salpingopharyngeal ostium, and (3) indicates the pharyngeal floor; the arrow depicts a left-sided fenestration in the dorsal pharyngeal recess made via transendoscopic laser. Specifically, the endoscope with laser through the working channel was passed via the contralateral nasal meatus. To create a unilateral fenestration that would keep the mesial septum intact, the midline of the DPR was visualized and the corners of the prospective fenestration were marked by briefly contacting the laser to the mucosa to make four dots in the shape of a 20 mm×20 mm square with the axial border parallel and 2-3 mm abaxial to midline. The dorsal and ventral horizontal incisions were made, followed by the abaxial then axial vertical incisions, to join the corners of the square. Side-bite bronchoesophageal forceps (equine laryngeal forceps; Karl Storz, Munich, Germany) were used via the ipsilateral nostril to stabilize and create tension in the resulting tissue flap during the final incision. Fistula size planning and final fistula size were measured using markings placed at 10 mm intervals on an over-bent Chambers catheter touching the mucosa at the proposed surgical site. This technique enabled viewing of measurements in the same plane without perspective error. All surgery was performed by an ACVS Surgical Resident with prior experience in transendoscopic laser surgery (GAC) with supervision from an ACVS diplomate (SHB) under laser safety protocols approved by Virginia Tech Environmental Health and Safety. Timing of laser surgical procedures started when the first corner marker was created and stopped when the last laser incision was completed. Survey endoscopy was performed at the completion of laser surgery to document appropriate fenestration and lack of mucosal damage.

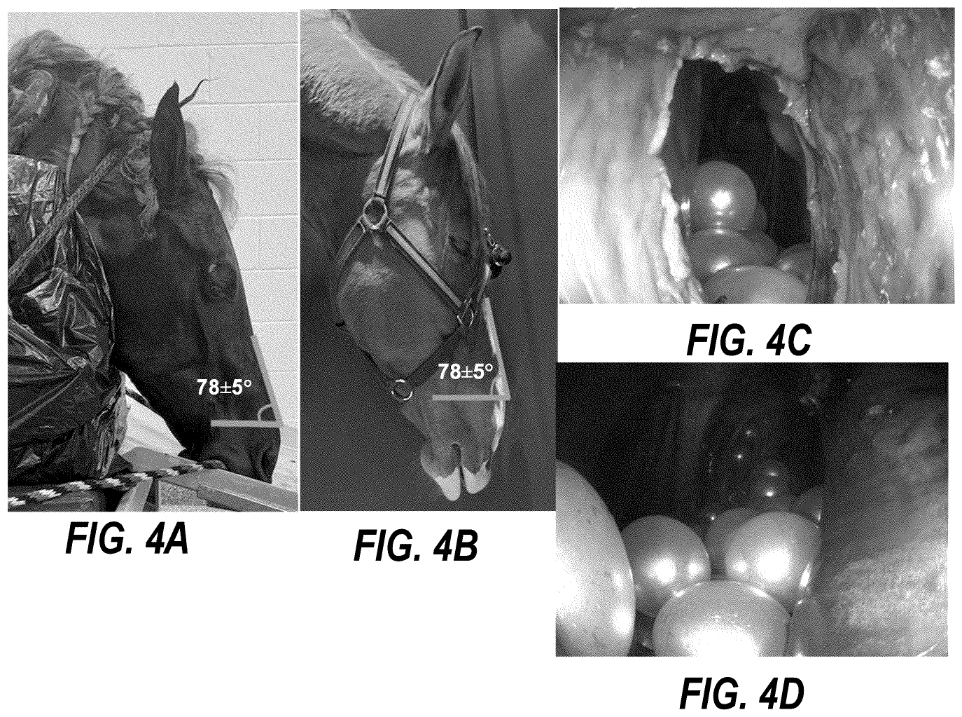

Upon completion of laser surgery, head angle was adjusted to 78±5° to mimic head angle of a horse under maximal sedation. This angulation was based on image analysis of 6 live horses using Photo Protractor App (Goemon-soft 2015, Japan) that found a range of 74.1° to 84.4° and mean±S.D of 78.18°±3.72° (FIGS. 4A-4D). A 17 mm diameter tube was passed over a 10 mm diameter tube guide and placed through the ipsilateral nostril and the DPR fenestration. Fifty smooth solid plastic spherical beads (12 mm diameter, 1 g/cm3 density, Inspirelle, Yiwu, China) were placed to mimic accumulation of chondroids within the GP. Beads were pushed through the 17 mm diameter tube 10 at a time using the 10-mm tube guide. Following bead placement, both tubes were removed under endoscopic guidance. Confirmation of bead placement into both medial and lateral compartments of the GP was performed endoscopically prior to performing all procedures.

### Bead Removal Procedures:

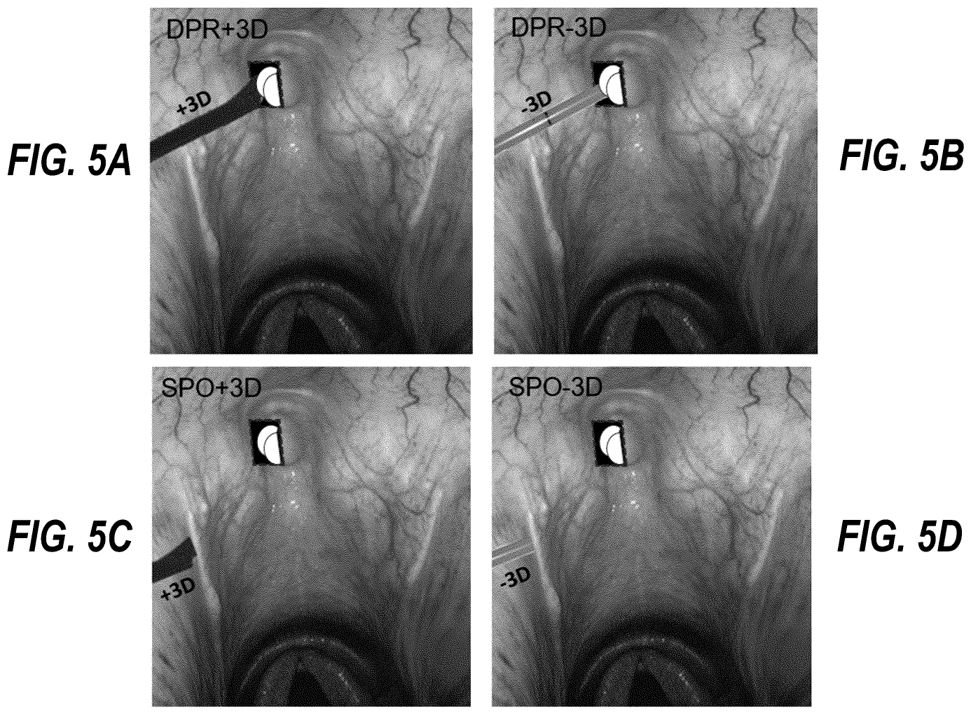

Following placement of the beads, bead removal procedures were performed. Four different procedures were compared, which varied by use of the 3D-instrument described vs. static lavage tube control and instrument insertion site (FIGS. 5A-5D). The lavage tube control was a straight insemination pipette protector with the same internal dimensions and length as the 3D-printed instrument (Continental Plastics, Delavan, WI). For each head, after the DPR fenestration was created, both procedures using instrument placement via the DPR (DPR+3D and DPR−3D, FIGS. 4A and 4B, respectively) or via the SPO (SPO+3D and SPO−3D, FIGS. 4C and 4D, respectively) were performed sequentially. Sequence of paired procedures was randomized using a coin toss. In this way, each head could have a maximum of 2 procedures performed. Each procedure was performed 10 times. All DPR+3D and DPR−3D procedures (Group 1) were completed prior to SPO+3D and SPO−3D procedures (Group 2). Lavage was controlled by an arthroscopic pump (Endomat Select ART-LA, Karl Storz, Munich, Germany) attached to the 3D-printed instrument for DPR+3D and SPO+3D procedures or the lavage tube control for DPR−3D and SPO−3D procedures. The 3D-printed instrument or insemination pipette protector were inserted through the ipsilateral nostril directly through the DPR fenestration or through the SPO. A marker on the 3D-printed instrument or pipette protector was used to ensure that the distal end of the instrument or protector was placed 10 cm into the GP from the fenestration or SPO opening. Lavage was performed for 30 seconds on followed by 15 seconds off for 2-minute cycles at 2500 mL/minute, with maximum pressure of 200 mmHg. Both the 3D-printed and lavage tube control techniques had the ability to deliver the same lavage volume during the given lavage time. During lavage, the 3D-printed instrument was slowly rotated ¼ turn with 3 cm in-and-out motions, whereas the insemination pipette protector lavage tube control remained static. The control technique with no motion was chosen for comparison to represent an unimproved lavage procedure that is commonly used clinically. Two-minute cycles were continued until either ≥96% of beads (48 beads) were removed, or 3 consecutive cycles yielded no beads. This cut-off was selected to account for beads refractory to removal based on pilot experiments during model development. Expelled beads were collected in a stainless-steel bucket, with strainer basket, placed directly under the nostrils for counting after every 2-minute cycle. Beads lodged in the nasal passages were identified during survey endoscopy and exteriorized prior to counting.

### Endoscopic Assessment:

Survey endoscopy was performed on the left and right side prior to fenestration (to rule out pre-existing pathology that would warrant exclusion from the study), after laser surgery and after every 2-minute lavage cycle to assess for soft tissue damage and remaining beads, using a checklist of anatomic structures: (1) ipsilateral pharyngeal view: left and right pharyngeal walls, SPO, dorsal pharyngeal wall and recess; (2) ipsilateral GP view: lateral and medial compartment caudal, ventral, dorsal aspects, median septum; and (3) nasal passage views: ventral, dorsal and middle meatus. Soft tissue damage was categorized as: laceration or burn with laser (<0.5 cm, 0.5-2 cm or >2 cm; partial or full thickness), communication of another cavity or rupture, or other (description recorded). Transendoscopic images were taken of all soft tissue damage that deviated from baseline endoscopy. Evidence of relative change from previously identified soft tissue damage was noted. Heads were replaced between procedures if damage occurred.

### Statistical Analyses:

Data for surgical time of laser fenestration, procedure time (number of

procedure cycles to reach an endpoint), number of beads removed after each cycle and total number of beads removed were recorded in Microsoft Excel and imported into SAS version 9.4 (Cary, NC, USA) for statistical analysis. Rate of bead removal was defined as a quotient between number of beads removed and number of cycles. Normal probability plots showed that all numerical outcome measures were not normally distributed. Accordingly, surgical times were summarized as medians (range). Total number of beads and rate of bead removal are reported as median (range) (raw data) with differences between least squares means. Categorical outcomes for presence and type of soft-tissue damage following laser surgical fenestration of the DPR, and after bead removal procedures were summarized as counts and percentages. Surgical time to create the DPR fenestration was compared between heads allocated to group 1 or group 2 using the Wilcoxon rank sum test. Rate of bead removal was defined as the quotient between number of beads removed and number of 2-minute lavage cycles. Effects of procedure on total number of beads and rate of bead removal were assessed using a linear generalized estimating equations (GEE) model. A successful procedure was defined as removal of ≥96% (48 beads) and a failed procedure as removal of <4% (2 beads). Successful and failed procedures in each group were compared using a logistic GEE model. Associations between post-operative complications and groups of heads were assessed using Fisher's exact test. Effects of laser surgery or bead removal procedure on soft-tissue damage were assessed using a logistic GEE model. For GEE analyses, comparisons of interest were extracted using contrasts. Where appropriate, P values were adjusted for multiple comparisons using Tukey's procedure. Statistical significance was set to P <0.05.

### Results

### Surgical Time:

The first group of heads in which DPR fenestration was performed had a significantly longer median time to perform laser fenestration compared to the second group (Group 1:20.4 minutes, range 9.4-40 minutes; Group 2:11.9 minutes, range 4.6-21.6 minutes) (P=0.04).

### Total Bead Removal:

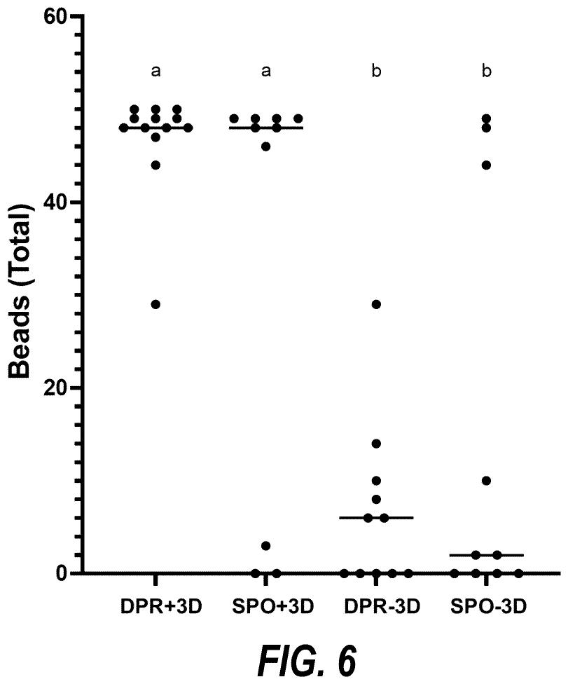

In all procedures, the plastic beads egressed entirely through the DPR fenestration. Bead removal procedures that used the 3D-printed instrument (DPR+3D, SPO+3D) yielded significantly more beads compared to procedures using lavage tube control (DPR−3D, SPO−3D) (P<0.001). There was no significant difference in the least square means of beads removed with the 3D-printed instrument placed through the DPR (DPR+3D) vs. the SPO (SPO+3D) (P=0.27) (FIG. 6).

### Probability of Complete Bead Removal Success and Failure:

Procedures using the 3D-printed instrument achieved a bead-clearance yield that was considered a success (≥96% removal) were successful on 73.91% of heads, which was significantly higher than procedures using the lavage tube control 9.52% (P<0.001). There was no difference in the proportions of successful procedures when the 3D-printed instrument was used via the DPR fenestration (84.6%) versus the SPO (60%) (P=0.34). The proportion of procedures considered failures (<4% removal) using the 3D-printed instrument was significantly lower (8.7%) than the proportion of procedures using the lavage tube control (52.4%) (P=0.001). There was no difference in the proportion of failed procedures using the 3D-printed instrument via the DPR fenestration (0%), compared to procedures with the 3D-printed instrument via the SPO (20%) (P=0.178).

### Rate of Bead Removal:

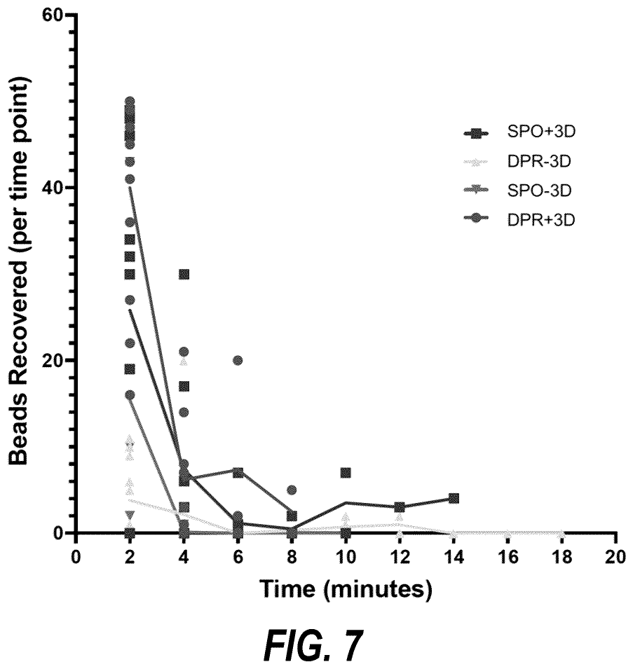

The number of beads removed over the number of lavage cycles (rate of bead removal) was significantly greater for procedures using the 3D-printed instrument (DPR+3D, SPO+3D) compared to procedures using the lavage tube control (DPR−3D, SPO−3D) (FIG. 7, P<0.001). There was no difference in the rate of bead removal between procedures that used the 3D-printed instrument (DPR+3D vs. SPO+3D) (P=0.45).

### Soft-Tissue Damage:

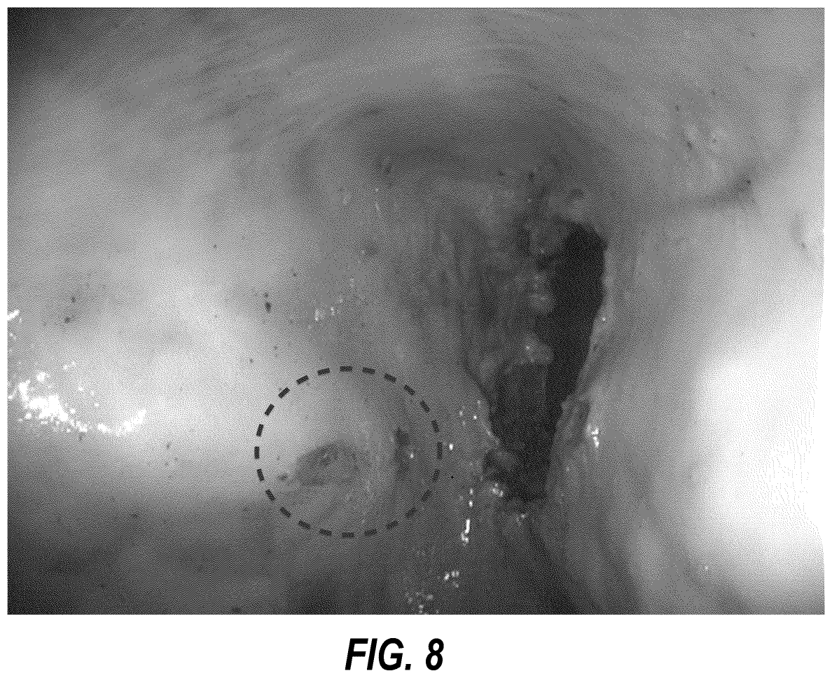

There was no difference in soft-tissue damage present after surgical laser fenestration of the DPR for the first (Group 1, 7/13 heads, 53.9%) compared to the second set of heads (Group 2, 3/10 heads, 30%) (P=0.40). When damage occurred, it was always <5 mm and partial thickness and did not cause communication between structures (FIG. 8).

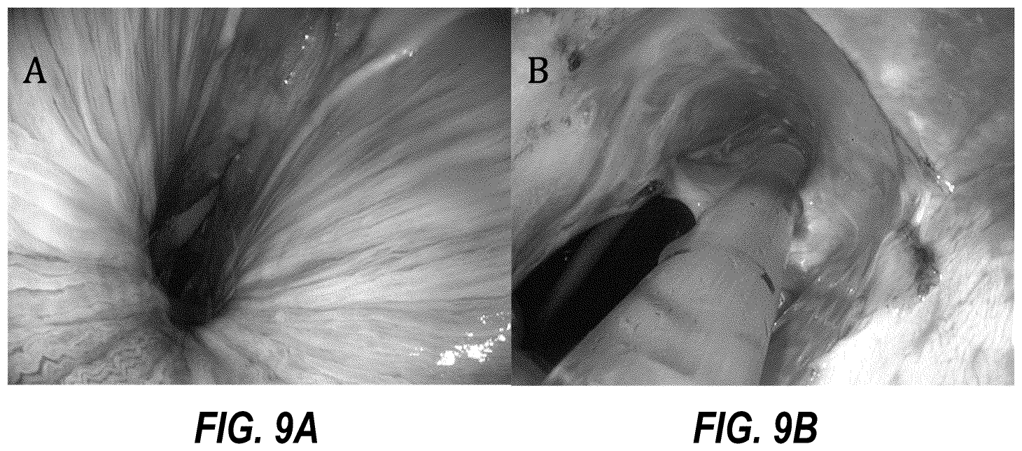

There was no difference in soft-tissue damage after bead removal procedures (DPR+3D, 4/13 heads, 30.8%; SPO+3D, 3/10 heads, 30%; DPR−3D, 3/11 heads, 27.3%; SPO−3D, 2/10 heads, 20%) (P=0.77). When damage occurred, it was always classified as other, seen during the ipsilateral pharyngeal view, and consisted of infiltration of fluids in the mucosa and submucosa creating different levels of mucosal and submucosal edema. In these cases, the damaged head was excluded from subsequent procedures. Review of endoscopic images showed that edema ranged from mild to moderate edema that narrowed the pharynx in one head (FIG. 9A). Edema that occurred in the mucosa/submucosa adjacent to the fenestration site caused occlusion of the fenestration in one head. (FIG. 9B).

### Discussion

Results of the cadaveric equine GP study provided above indicated that use of a 3D-printed instrument cleared more plastic beads in less time compared to the lavage tube control, confirming our first hypothesis. Plastic bead removal through a DPR fenestration was equally successful with the instrument placed directly through the DPR fenestration, or through the SPO, leading us to reject our second hypothesis. Using the 3D-printed instrument did not create more soft tissue damage compared to lavage only. Overall, this study using a cadaver model shows that use of our 3D-printed instrument with DPR fenestration can clear chondroids from the guttural pouch of horses with little to no soft tissue damage.

Advantageously, chondroid removal using the 3D-printed instrument with DPR fenestration increased procedural efficiency compared to current transendoscopic or lavage removal techniques. Using existing techniques, minimally invasive chondroid removal is extremely time consuming, requiring repeated passage of the endoscope to remove ensnared debris. In one case series, chondroid removal using a transendoscopic basket was performed over multiple days and was ultimately unsuccessful in 2/5 cases. This approach is similar to protocols historically used in our hospital (HCM, personal communication). The novel technique described in this study provides an approach to more efficiently remove chondroids. 3D-printed instrument procedures removed ≥96% of beads in the first 2 cycles (4 minutes) and overall median surgical time for laser fenestration was 20 minutes, making total procedural time less than 30 minutes. Reduced procedural time is an important advantage for the clinician, patient, and hospital biosecurity by freeing clinician time, incurring less procedural cost and having less time of exposure of hospital facilities and equipment to infectious organisms like S. equi subsp equi.

This study provides a description of a technique using a novel 3D-printed instrument. We chose to compare the technique to a control procedure using lavage tubing that was the same diameter and delivered the same flow rate and fluid volume as the 3D-printed instrument. The lavage tubing was kept stationary during control procedures to allow comparison to an unimproved lavage technique. There is the potential that movement of straight tubing may have elicited movement between plastic beads lodged at the DPR fenestration or altered fluid dynamics during lavage to improve bead yield. During development of the 3D-printed instrument, the curvature and hole placement improved lavage fluid dynamics by clustering beads centrally. Furthermore, the impetus to develop this instrument came from frustration while using plain lavage tubing for clinical cases. Development of an improved technique compared to standard lavage tubing that is widely available was a key goal. Here, we demonstrated that using the 3D-printed instrument as described improves outcomes compared to a traditional stationary lavage technique.

3D-printing allows cost-effective manufacture of single-use instruments and the potential to customize the tool for individual patients. 3D printing software enables customization of instrument length and size, which could allow tailoring for draft or miniature horse patients. Printing single instruments for use in patients with high biosecurity risk due to the highly infectious nature of S. equi subsp equi is an important consideration. 3D printers are readily available at academic institutions, through private commercial printing companies, or for individual sale, making a single-use instrument with published dimensions and printing techniques a reasonable option for instrument manufacture.

There was a significant learning curve with increased surgical efficiency through repetition of the transendoscopic Nd:YAG laser surgery used to create the fenestration in the DPR. DPR fenestrations created in group 1 heads took a significantly longer time than fenestrations created for group 2 heads. This is likely because group 1 had fenestrations performed before group 2, allowing the surgical resident to gain experience and confidence with the surgical technique and decision making. Performing transendoscopic laser surgery requires the surgeon to consider multiple variables including power, tissue effect and endoscope manipulation to create an incision, so experience is an important factor on surgery time. Transendoscopic laser surgery is a safe alternative to open surgery, is commonly used in upper airway surgery following appropriate training and can be performed in standing sedated horses.

When developing our second hypothesis, we expected that the 3D-printed instrument acting on beads at the DPR fenestration opening would make instrument placement via the fenestration more effective than via the SPO. However, our results show no loss of procedural efficiency when 3D-printed instrument procedures were performed via the DPR fenestration vs. the natural SPO. Potential loss of egress diameter with direct placement of the instrument is one consideration for this finding. For horses with chondroids and concurrent fibrosis of the SPO, creation of a fenestration in the DPR represents a unique advantage. Fibrosis of the SPO can occur due to inflammation from chronic infection in a subset of horses with chondroids. Fenestration into the affected GP through the mesial septum from the healthy GP has been reported to access chondroids for transendoscopic removal. The key limitation of mesial septal fenestration is indirect access to the chondroids, making removal technically challenging. DPR fenestration creates access to the affected GP for the lavage instrument as well as a direct route of chondroids egress.

DPR fenestration with a transendoscopic laser is less invasive compared to open surgical chondroid removal techniques; however, potential complications have been described. Complete healing time varies from weeks to months following surgery, but can be longer. Reported complications following DPR fenestration are rare and include granulation tissue formation at the fistula site and patent fistula formation. Granulation tissue can be removed with bronchoesophageal forceps or may heal spontaneously without further surgical intervention. Persistence of the fistula does not appear to pose further problems for the horse and has been proposed to help with resolution of infection in chronically infected GP. Cook reported food impaction on a ventrally located fistula in one horse, but there have been no other reports of food impaction or dysphagia. It was hypothesized that fistulation of the GP could disturb airway dynamics, guttural pouch function, pharyngeal function, and soft-palate placement during strenuous activity. However, airway dynamics are not altered as a result of GP fenestration, according to recent reports. Although only superficial mucosal laser lacerations or burns <5 mm were reported in this study, deeper laser tissue-effects and subsequent healing of the DPR fenestration could not be ascertained without live tissue.

The cadaveric nature of this study does limit extrapolation of data to the treatment of clinical cases. Soft-tissue damage following chondroid removal procedures was mild to moderate pharyngeal mucosal edema that did not obstruct the lumen of the pharynx or the fenestration site in most cases. It is unknown if airway obstruction could occur in live sedated horses. Movement of fluid between tissue planes at the level of the fenestration and subsequent mucosal flap formation could occlude the fenestration site and impede progress in a clinical case by preventing re-introduction of the 3D-printed instrument or egress of chondroids. However, similar tissue changes in response to GP lavage with DPR fenestration have not been reported in live animals, so this phenomenon could be attributed to decreased adhesion of cadaveric tissue layers. Additionally, our model did not make it possible to assess hemorrhage or damage to neurological structures within the guttural pouch.

The procedures described in this study may establish a safety improvement to lavage with no fenestration by creating a permanent opening for free fluid egress^{6,10} and using a pressure-limiting pump during lavage. Another limitation related to the cadaveric nature of this study is that patient tolerance to the procedure could not be assessed. However, Koch, et al. performed transendoscopic laser fenestration of the DPR and lavage of the guttural pouches in clinical cases with good patient tolerance. Uniform sized plastic beads were used to allow standardization of the cadaveric model; however, they may not accurately represent the size, shape, weight and texture of naturally occurring chondroids. Chondroids can vary in size from 10-50 mm and may be ovoid to angular in shape; however, detailed studies that report sizes and weights of chondroids are lacking. In cases with larger chondroids, chondroids could be transected with a transendoscopic snare or scissors prior to removal.

Using the 3D-printed instrument, coupled with lavage using the technique described, was effective in clearing more plastic beads in less time compared to static lavage tubing through a DPR fenestration and without a difference in complications in this equine cadaveric model. Placement of the 3D instrument directly through the fenestration or through the SPO did not affect the ability to remove plastic beads through the DPR fenestration. DPR fenestration using transendoscopic laser can be easily learned and represents a noteworthy new technique for chondroid removal in standing sedated horses. Procedural tolerance and safety assessment in live horses is warranted.

### SELECTED REFERENCES

Barakzai SZ, Macaulay E, Burrows IL: Creation of salpingopharyngeal fistulae for the management of guttural pouch tympany and persistent guttural pouch empyema. Equine Veterinary Education 35, 2022.
Barton AK, Cehak A, Rohn K, et al: Transendoscopic laser surgery to correct nasopharyngeal obstruction caused by head flexion in horses. Vet Surg 43:418-424, 2014.
Berger N, Eeg PH: Veterinary Laser Surgery (ed First edition), Blackwell Publishing, 2006.
Boyle AG, Timoney JF, Newton JR, et al: Streptococcus equi Infections in Horses: Guidelines for Treatment, Control, and Prevention of Strangles-Revised Consensus Statement. J Vet Intern Med 32:633-647, 2018.
Christmann U, Pink C: Lessons learned from a strangles outbreak on a large Standardbred farm. Equine Veterinary Education 29:138-143, 2017.
Cook WR: The clinical features of guttural pouch mycosis in the horse. Vet Rec 83:336-345, 1968.
Cramp PA, Prange T, Nickels FA: Standing equine surgery of the upper respiratory tract. Vet Clin North Am Equine Pract 30:111-141, 2014.
DeLoache P, Whelchel D, Beetz R, et al: Guttural pouch empyema caused by Corynebacterium pseudotuberculosis in a pregnant mare. Equine Veterinary Education 30:76-79, 2018.
Dixon PM, James OA: Equine guttural pouch empyema, why does it become chronic? Equine Veterinary Education 30:80-84, 2018.
Fogle CA, Gerard MP, Johansson AM, et al: Spontaneous rupture of the guttural pouch as a complication of treatment for guttural pouch empyema. Equine Veterinary Education 19:351-355, 2007.
Freeman DE: Complications of surgery for diseases of the guttural pouch. Vet Clin North Am Equine Pract 24:485-497, vii, 2008.
Gehlen H, Ohnesorge B: Laser fenestration of the mesial septum for treatment of guttural pouch chondroids in a pony. Vet Surg 34:383-386, 2005.
Hardy J, Léveillé R: Diseases of the guttural pouches. Veterinary Clinics of North America: Equine Practice 19:123-158, 2003.
Hawkins JF, Andrews-Jones L: Neodymium:yttrium aluminum garnet laser ventriculocordectomy in standing horses. Am J Vet Res 62:531-537, 2001.
Hawkins JF, Frank N, Sojka JE, et al: Fistulation of the auditory tube diverticulum (guttural pouch) with a neodymium: yttrium-aluminum-garnet laser for treatment of chronic empyema in two horses. J Am Vet Med Assoc 218:405-407, 361, 2001.
Henderson CE, Sullins KE, Brown JA: Transendoscopic, laser-assisted ventriculocordectomy for treatment of left laryngeal hemiplegia in horses: 22 cases (1999-2005). J Am Vet Med Assoc 231:1868-1872, 2007.
Jukic CC, Cowling NR, Perkins NR, et al: Evaluation of the effect of laser salpingopharyngostomy on the guttural pouch environment in horses. Equine Vet J 52:752-759, 2020.
Koch DW, Easley JT, Nelson BB, et al: Comparison of two techniques for transpharyngeal endoscopic auditory tube diverticulotomy in the horse. J Vet Sci 19:835-839, 2018.
Koch DW, Ericksen KA, Easley JT, et al: Clinical outcome of horses with guttural pouch infection following transpharyngeal fenestration. J Am Vet Med Assoc 260:1211-1215, 2022.
Krebs W, Schmotzer WB: Laser fenestrated salpingopharyngeal fistulas for treatment of bilateral guttural pouch tympany in a foal. Equine Veterinary Education 19:419-423, 2007.
Munoz JA, Stephen J, Baptiste KE, et al: A surgical approach to the lateral compartment of the equine guttural pouch in the standing horse: modification of the forgotten “Garm technique”. Vet J 177:260-265, 2008.
Newton JR, Wood JL, Dunn KA, et al: Naturally occurring persistent and asymptomatic infection of the guttural pouches of horses with Streptococcus equi. Vet Rec 140:84-90, 1997.
Perkins JD, Schumacher J, Kelly G, et al: Standing surgical removal of inspissated guttural pouch exudate (chondroids) in ten horses. Vet Surg 35:658-662, 2006.
Schaaf KL, Kannegieter NJ, Lovell DK: Surgical treatment of extensive chondroid formation in the guttural pouch of a Warmblood horse. Aust Vet J 84:297-300, 2006.
Tate LP, Jr., Blikslager AT, Little ED: Transendoscopic laser treatment of guttural pouch tympanites in eight foals. Vet Surg 24:367-372, 1995.
Verheyen K, Newton JR, Talbot NC, et al: Elimination of guttural pouch infection and inflammation in asymptomatic carriers of Streptococcus equi. Equine Vet J 32:527-532, 2000.

Watkins AR, Parente EJ: Salpingopharyngeal fistula as a treatment for guttural pouch mycosis in seven horses. Equine Vet J 50:781-786, 2018.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A device for lavage of a deeply recessed area, comprising:
a hollow insertion portion, the insertion portion comprising a straight portion and a curved distal end having a fluid egress aperture on a convex side of the curve, wherein the curved distal end is flexible; and
a rigid tubular handle connected to the straight portion of the hollow insertion portion.

2. The device of claim 1, wherein the curved end terminates in a bulbous nub.

3. The device of claim 1, wherein the curved end is scoop-shaped.

4. The device of claim 1, wherein the insertion portion and the tubular handle are removably connected.

5. The device of claim 1, wherein the insertion portion and the tubular handle are integrally connected.

6. The device of claim 1, wherein the proximal end of the tubular handle comprises a connector to attach to an end of a dosing syringe.

7. The device of claim 1, wherein the straight portion is more rigid than the curved distal end.

8. The device of claim 1, wherein one or both of the insertion portion and the rigid tubular handle are disposable.

9. The device of claim 1, wherein one or both of the insertion portion and the rigid tubular handle are reusable and formed from a sterilizable material.

10. A method for fluid lavage of a deeply recessed area, the method comprising:
receiving, in a proximal end of a device for lavage egress, a lavage tube connected to a fluid source;
inserting a distal end of the device for lavage egress into the deeply recessed area such that at least a flexible curved distal end of the device enters the deeply recessed area; and
lavaging the deeply recessed area through a fluid egress aperture on a convex side of the curved distal end.

11. The method of claim 10, further comprising loosening chondroids by agitating the chondroids with the flexible curved distal end of the device.

12. The method of claim 10, wherein the deeply recessed area is selected from a guttural pouch, a bladder, a cervix, a uterus, and an ear canal.

13. The method of claim 10, wherein the device for lavage egress is inserted into a fenestration in an equine dorsal pharyngeal recess.

14. The method of claim 10, wherein the device for lavage egress is inserted into an equine salpingopharyngeal ostium.

15. A tool for equine chondroid removal, comprising:
a hollow insertion portion, the insertion portion comprising a straight portion and a curved distal end having a fluid egress aperture on a convex side of the curve, wherein the curved distal end is flexible and wherein the curved end terminates in a bulbous nub; and
a rigid tubular handle connected to the straight portion of the hollow insertion portion.

16. The tool of claim 15, wherein the hollow insertion portion comprises mm flexible thermoplastic polyurethane.

17. The tool of claim 15, wherein the curved portion has a curvature of about 20 degrees.
